(19) United States
(12) Patent Application Publication
(10) Pub. No.: US 2016/0113735 A1
(43) Pub. Date: Apr. 28, 2016

(54) ROOT CANAL INSTRUMENT HAVING AN OVOID OR OVAL SECTION

(71) Applicant: MICRO MEGA INTERNATIONAL MANUFACTURES, Besancon (FR)

(72) Inventor: Guy LEVY, Marseille (FR)

(73) Assignee: Micro Mega International Manufactur

(21) Appl. No.: 14/894,289

(22) PCT Filed: May 28, 2014
(86) PCT No.: PCT/FR2014/051277

§ 371 Date: Nov. 25, 2015

(30) Foreign Application Priority Data
May 30, 2013 (FR) 13 01230

(51) Int. Cl. A61C 5/02

(52) U.S. Cl. CPC A61C 5/023

(57) ABSTRACT

The root canal instrument for preparing a housing for a pivot inside dental roots includes a working part extending along a longitudinal axis. A cross-section of a frustoconical envelope of the working part embodying an elliptical section or an ovoid section or an oblong section or a section of the type includes a front circle portion and a rear circle portion joined by two side bend portions. A diameter of the front circle portion is longer than or equal to a diameter of the rear circle portion.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The invention relates to a root canal instrument for preparing a recess for a pivot inside the dental roots.

2. Description of Related Art Including Information Disclosed Under 37 CFR 1.97 and 37 CFR 1.98

The pulpless teeth often require the installation by sealing or screwing of a pivot for supporting a restoration of the crown. To this end, it is known to drill a space in the root canal by means of round drills the cutting of which occurs in rotation by means of contra-angles or handpieces. The preparation is thus round and is performed at the expense of the walls of the channel and does not respect the anatomy of the roots, in particular the flat or curved ones, since these drills are rigid and straight. The rotary implementation of these instruments may result into a weakening of the walls, especially the mesial walls or the distal walls, and may afterwards result into fractures or, during the preparation, into perforations compromising the future of the dental organ. The space created during the preparation of the root canal is then provided with a pivot with a circular cross-section, standardized to the dimensions of the drill, in particular to its round cross-section.

### BRIEF SUMMARY OF THE INVENTION

The invention provides a novel instrument, which does not have all or part of the drawbacks of the existing instruments. More specifically, the invention provides a novel root canal instrument characterized in that it includes a working portion extending along a longitudinal axis, a frustoconical casing of the working part having, in a cross-sectional view, a cross-section of the type comprising a front curve portion and a rear curve portion united by two side curve portions, a radius of curvature of the front portion being larger than or equal to a radius of curvature of the upper portion.

The novel instrument, with its cross-section that is no longer circular, but rather more or less flattened, permits to perform preparations in harmony with the root anatomy, in particular with that of the roots that have an ovoid or flattened cross-section and to avoid the weakening of the walls by performing a preparation directed to thicker safety areas of the root. Depending on the shape of the roots, the cross-section of the instrument will be chosen ovoid, elliptical, oblong, or more generally as defined above.

In the instrument according to the invention, the casing as a whole comprises a front face and a rear face united by two lateral faces, the front face and the rear face corresponding to the areas of the casing farthest away from each other; each face extending all along the casing and has, in a transverse plane, a cross-section having the shape of a curve portion, as the case may be, a front portion, a rear portion and side portions, respectively, as defined above.

Preferably, for example for roots having flat zones may be chosen an instrument according to the invention, the two side faces of which are planar.

The instrument according to the invention preferably includes, all along the working part, one or several blades permitting to cut the root canal walls during a reciprocating longitudinal movement of said instrument. Thus, the instrument cuts the dentin of the canal walls during reciprocating longitudinal movements and no longer as a cut by rotation of the instrument. This reciprocating longitudinal movement can be performed manually, the instrument being held between the fingers, or in an automated manner using a contra-angle imparting to the instrument a longitudinal reciprocating movement of variable amplitude as described by Levy in Patent FR 2563101 entitled “Driving head for instruments for endodontic interventions” and published on 1985-10-25. Preferably, the instrument according to the invention is provided with blades reproducing the characteristics of a K-type file, thus active longitudinally in both directions, or reproducing the characteristics of the Hedstroem limes.

The mesial and distal roots of the lower and upper molars have ovoid or flat channels on roots of the same shape with particularly thick buccal walls, slightly thinner lingual faces. We find this peculiarity on the lower and upper premolars or on the lower incisors and the canines. Thus, for making of space for a pivot in this type of root, it is preferable to provide for same at the expense of the thickest wall, i.e. the buccal wall and to a lesser extent at the expense of the lingual or palatal wall, finally to a limited extent at the expense of the mesial or distal walls, in order to prevent a perforation of the wall on the periodontium. To this end, an instrument according to the invention can have, in the working part, deeper and more active blades on the front face and the rear face relative to the blades present on the side faces. Thus, the cutting occurs preferentially on the buccal walls, to a lesser extent on the lingual or palatal wall and finally to a limited extent on the mesial and distal faces.

Longitudinally an instrument according to the invention has for example a 12 mm long active part, the tip being preferably made of foam and generally blunt. This total length of the working part may be more generally within the range from 10 to 16 millimeters, in order to meet uses of instruments on short or long roots.

According to a variant, the instrument comprises at least one helical blade extending from a heel (i.e. the gripping end or the end for connecting to a driving tool) to a tip (i.e. the free end) of the working part of the instrument. According to another variant, the instrument comprises a plurality of blades distributed along the working part, each blade extending in a plane no longer non-parallel to the longitudinal axis and preferably in a plane substantially perpendicular to the axis longitudinal.

Even more preferably, the blade or blades are less deep at the tip than at the heel of the working part. In other words, the depth of the blade or blades increases from the tip of the working part to the heel of the working part. This permits to start the widening of the channel with little active blades, then to increase the force exerted on the wall of the channel as the instrument penetrates into the channel.

Finally, the invention relates to a pivot standardized to the dimensions of the working part of an instrument according to the invention as described above, characterized in that it is accommodated very exactly in the space created in the roots by said instrument.

Such a pivot is preferably made of steel and titanium alloy, or of plastic material, of resin or burn-out material.

### BRIEF DESCRIPTION OF THE SEVERAL VIEWS OF THE DRAWINGS

The invention will be better understood and further features and advantages of the invention will become clear from the following description of exemplary embodiments of an instrument according to the invention. These examples are given in a non-restrictive way. The description should be read with reference to the attached drawings.

FIG. 1 shows a front elevation view of an instrument according to the invention.

FIGS. 2a, 3a, 4a, 5a show cross-sectional views of various examples of the instrument of FIG. 1, close to the tip of the instrument (section A-A).

FIGS. 2b, 3b, 4b, 5b show cross-sectional views of different examples of the instrument of FIG. 1, close to the heel of the instrument (section B-B).

FIGS. 6 to 10 show the elevation views and cross-sectional views of variants of the instruments of FIGS. 1 to 5.

### DETAILED DESCRIPTION OF THE INVENTION

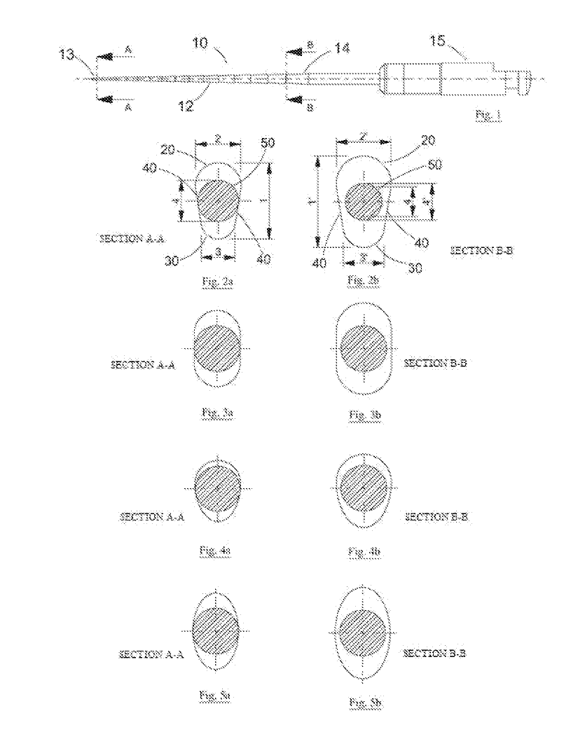

FIG. 1 shows, by way of an example, an instrument 10 according to the invention comprising a 10 mm long cut working part 12 extending along a longitudinal axis, the working portion comprising a tip 13 and a heel 14, heel extended by gripping handle 15 or by a handle for connecting to a driving tool.

According to the invention, a frustoconical casing of the working part has, in a cross-sectional view, a cross-section of the type comprising a front curve portion 20 and a rear curve portion 30 united by two side curve portions 40, a radius of curvature 2 of the front portion 20 being larger than or equal to a radius of curvature (3) of the upper portion 30.

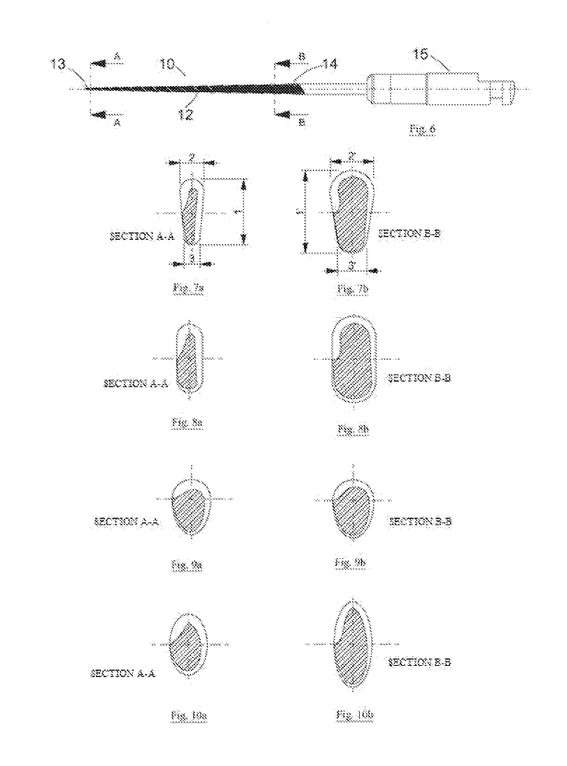

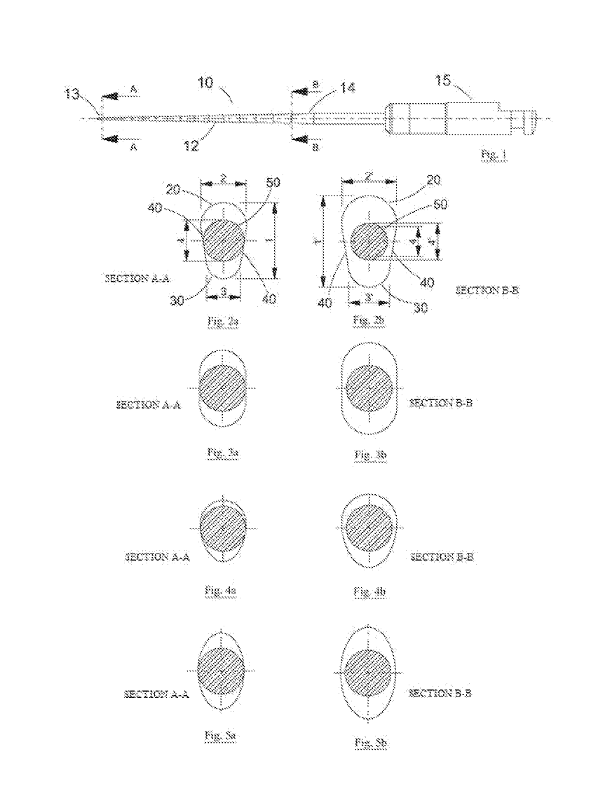

FIG. 2b shows an example of a cross-section (section B-B) of the instrument 10, close to the heel of the working part 12, in which example:
the front portion 20 and the rear portion 30 of the cross-section are portions of a circle, semi-circles, more specifically, the diameter (=radius of curvature in this particular case) 2 of the front portion being larger than the diameter 3 of the rear portion 30, and
the two side portions are planar and non-parallel.

The total casing of the working part comprises a front face and a rear face united by two side faces, the front face and the rear face corresponding to the areas of the casing farthest away from each other; each face extending all along the casing and has, in a transverse plane, a cross-section having the shape of a curve portion, as the case may be, a front portion 20, a rear portion 30 and side portions 40, respectively.

In the example of FIG. 2b, the two side portions 40 of the cross-section are planar and non-parallel, and the diameter 2′ of the front portion of a circular 20 is larger than the diameter 3′ of the rear portion of a circle 30; the maximum width (1′) of the cross-section is 100/100ths of a millimeter, the front portion of a circle has a diameter 2′ of 60/100ths of a millimeter and the rear portion of a circle has a diameter 3′ of 40/100ths of a millimeter. We remind that the front face instruments the buccal face of the channels, and the rear face instruments the lingual face of the channel, i.e. generally speaking, both sides corresponding to the largest thicknesses of the roots.

FIG. 2a shows the cross-section of the same instrument as that of FIG. 2b, but close to the tip (section A-A) of its working part: the cross-section has the same shape as in FIG. 2b, but is smaller: its maximum width (1) is 60/100ths of a millimeter with a front portion of a circle of 36/100th of a millimeter in diameter 2 and a rear portion of 24/100ths of a millimeter in diameter 3.

In the working part of the instrument, blades are formed by machining a solid metal wire, for example of nickel-titanium, preferably with a helix angle of 45° and a positive cutting angle.

This machining may be circular, providing a central core 50 of 30/100th of a millimeter in diameter at the tip of the working part, which ensures deep and active blades on the rounded faces of the instrument and zero on part of the side and divergent faces. In the example of FIGS. 2a, 2b, the circumference of the central core increases slightly from the tip (diameter 4) to the heel of the working part of the instrument in order to reach a diameter 4′ of 40/100ths of a millimeter, which permits to provide shallow blades at the tip of the working part of the instrument, but increasingly more active when going up this working part, and this on the side faces of the instrument.

Starting from the example of FIGS. 1-2, different variants are possible, which can be considered alone or in combination.

For example, the portions of a circle 20, 30 of the instrument may have a diameter 2, 3 equal on their semi-circle, this provides parallel planar side curves 40 and a globally oblong cross-section of the instrument, as shown in FIGS. 3a and 3b.

Or, the instrument may have a cross-section with an ovoid (FIG. 4a-4b) or elliptical (FIG. 5a-5b) shape. Such shapes are obtained by simply choosing short curve portions 20, 30 and non-planar side curve portions 40.

Also, the maximum widths (1 and 1′) at both ends of the working part (the tip and the heel) can vary. For example, with maximum widths of 120/100ths to 140/100ths of a millimeter for the heel (1′) and from 60 to 80/100ths of a millimeter for the second (1).

In the example of FIG. 1, the instrument comprises a plurality of cutting blades distributed along the working portion, each blade being cut in a transverse plane of the working part, i.e. in a plane perpendicular to the longitudinal axis of the instrument. In FIGS. 2 to 5:
the curve in solid line defines the shape of the casing of the working part,
the striped central portion corresponds to the central core of the working part after cutting of the blades, the sections A-A and B-B being performed voluntarily at the level of a blade.

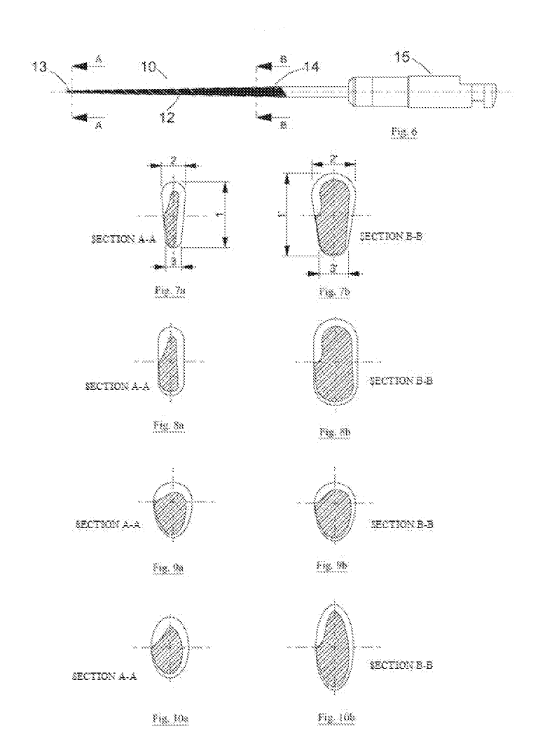

As a variant, FIG. 6 shows an instrument comprising a single helical cutting blade extending from the heel to the tip of the working part. FIGS. 7 to 10 show various possible cross-sections for the instrument of FIG. 6 after cutting of the blade as before:
in solid lines, the shape of the casing of the working part,
the striped part, the central core of the working part.

The machining occurs by grinding on solid wires or rods made of special steels, based on stainless steel or on an alloy comprising titanium and nickel. For creating the blades, this machining may be circular, it may also be elliptical, which permits to adjust the depth of the blades around the instrument. Once the machining is completed, the instrument may be subjected to a bending of 10° relative to the main axis of the mesial side towards the distal side on its last working third (distal side of the blade), in order to prepare curved channels: this permits to close the cutting angle of the blades on the inner side of the curvature of the instrument and to open the cutting angle on the outer side of the curvature of the instrument; this makes the instrument less aggressive on its inner face and more aggressive on its outer face; this also avoids the rectification of the curvature, hence the root perforations.

According to the invention, a pivot standardized to the working part of the instrument is inserted into the gap left in the root, in order to be sealed therein. This pivot can be formed from materials of different natures: titanium, fiberglass, plastics, resins or burn-out materials. The pivot includes an intra-ductal part and an extra-ductal part. This extra-ductal part can strengthen the restoration of a crown. This extra-ductal part has different shapes and lengths and can be adjusted by grinding.

### NOMENCLATURE

FIG. 1
10 instrument
12 working part
13 tip
14 heel

15 handle

FIG. 2a cross-section at the tip:
1 maximum length of the cross-section
2 diameter of the curvature of the front portion of a circle
3 diameter of the curvature of the rear portion of a circle
4 diameter of the central core

FIG. 2b: cross-section at the heel:
1′ maximum length of the cross-section
2′ diameter of the curvature of the front portion of a circle
3′ diameter of the curvature of the rear portion of a circle
4′ diameter of the central core

1-11. (canceled)

12. A root canal instrument for preparing a recess for a pivot inside the dental roots, comprising:
a working part extending along a longitudinal axis; and
a plurality of blades permitting to cut root canal walls during a reciprocating longitudinal displacement, said working part having a frustoconical casing having a cross-section comprised of a front curve portion and a rear curve portion united by two side curve portions, wherein a radius of curvature of said front curve portion is larger than or equal to a radius of curvature of said rear curve portion.

13. The instrument, according to claim 12, wherein the two side curve portions are planar.

14. The instrument, according to claim 12, wherein the front curve portion and the rear curve portion are portions of a circle.

15. The instrument, according to claim 12, wherein said cross-section is an ovoid or elliptical cross-section.

16. The instrument, according to claim 12, wherein said plurality of blades comprises at least one of a group consisting of:
a helical blade extending from a heel to a tip of the working part, and
a plurality of blades distributed along the working portion, each blade extending in a plane non-parallel to the longitudinal axis and preferably in a plane substantially perpendicular to the longitudinal axis.

17. The instrument, according to claim 5 16, wherein the casing comprises a front face and a rear face united by two side faces, the front face and the rear face corresponding to the areas of the casing farthest away from each other, and wherein the blades are deeper and more active on the front and rear surfaces in comparison with the blades present on the side faces.

18. The instrument, according to claim 12, wherein each blade is less deep close to a respective tip than close to a heel of the working part.

19. An assembly, comprising:
a root canal instrument, according to claim 12; and
a pivot standardized to dimensions of the working part, said pivot being accommodated very exactly in space created in roots by the instrument.

20. The assembly, according to claim 19, said pivot being comprised of a steel and titanium alloy.

21. The assembly, according to claim 19, said pivot being comprised of at least one of a group consisting of: plastic material, resin and burn-out material.
